(19) United States
(12) Patent Application Publication
(10) Pub. No.: US 2013/0149131 A1
(43) Pub. Date: Jun. 13, 2013

(54) SURROUND FOR A VERTICAL AXIS WIND TURBINE

(71) Applicant: Kevin O'Keefe, Plymouth, MI (US)

(72) Inventor: Kevin O'Keefe, Plymouth, MI (US)

(21) Appl. No.: 13/712,796

(22) Filed: Dec. 12, 2012

Related U.S. Application Data
(60) Provisional application No. 61/630,382, filed on Dec. 12, 2011.

(51) Int. Cl. F03D 11/00

(52) U.S. Cl. CPC F03D 11/00
USPC 415/208.1

(57) ABSTRACT

A surround for housing a wind turbine directs and concentrates wind from any direction toward the wind turbine. The surround can be formed from an upper apron and a lower apron, each having three or more sides, typically four sides. A fin can be disposed between the upper and lower aprons and extend from a corner thereof toward a central region. The wind turbine can be disposed in the central region. Openings formed on each side of the surround are defined by the upper and lower aprons and the two fins extending from each corner on that side. The openings can deliver wind, from any direction, toward the wind turbine. The upper and lower aprons may angle inward to further concentrate and direct wind toward the wind turbine.

### CROSS-REFERENCE TO RELATED APPLICATION

This application claims the benefit of priority of U.S. provisional application No. 61/630,382, filed Dec. 12, 2011, the contents of which are herein incorporated by reference.

### BACKGROUND OF THE INVENTION

The present invention relates to turbine shrouds and, more particularly, to a 360 degree surround for a vertical axis wind turbine.

Wind speed and direction often vary during the course of a day. This makes it difficult to efficiently capture wind forces for a fixed wind turbine.

Current turbine technology is adversely affected by structures, landscaping, and terrain. This makes it difficult to locate turbines in optimal locations. The other devices are more expensive to construct and maintain because of their lack of proximity to their point of use. Other wind turbines have to be located too far away from point of use and require a completely separate structure to support it.

As can be seen, there is a need for a device that allows a wind turbine to be mounted to a structure, collect the wind more efficiently and create power.

### SUMMARY OF THE INVENTION

In one aspect of the present invention, a surround for a wind turbine comprises an upper apron; a lower apron; a plurality of fins disposed between the upper apron and the lower apron; and a central region formed between the upper apron and the lower apron operable to contain a wind turbine, wherein the plurality of fins extend from an outer perimeter of the upper apron and the lower apron toward the central region, and wind blowing on the surround from any direction is directed by the fins toward the central region.

In another aspect of the present invention, a surround for a wind turbine comprises an upper apron; a lower apron; a central region formed between the upper apron and the lower apron operable to contain a wind turbine; fins extending from each outer perimeter corner of the upper apron and the lower apron toward the central region, wherein wind blowing on the surround from any direction is directed by the fins toward the central region; the central region has a height smaller than an height of the surround between the upper apron and the lower apron at the outer perimeter thereof; and the upper apron and the lower apron have a slope operable to direct wind toward the central region.

These and other features, aspects and advantages of the present invention will become better understood with reference to the following drawings, description and claims.

### BRIEF DESCRIPTION OF THE DRAWINGS

FIG. 1 is a perspective view of a wind turbine surround, with a wind turbine installed therewithin, according to an exemplary embodiment of the present invention;

FIG. 2 is a side view of the wind turbine surround of FIG. 1;

FIG. 3 is a partially exploded perspective view of the wind turbine surround of FIG. 1, showing the top apron removed for clarity;

FIG. 4 is a cross-sectional view taken along line 4-4 of FIG. 2, illustrating a clockwise wind turbine rotation design; and

FIG. 5 is a cross-sectional view taken along line 4-4 of FIG. 2, illustrating a counter-clockwise wind turbine rotation design.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a surround for housing a wind turbine that directs and concentrates wind from any direction toward the wind turbine. The surround can be formed from an upper apron and a lower apron, each having three or more sides, typically four sides. A fin can be disposed between the upper and lower aprons and extend from a corner thereof toward a central region. The wind turbine can be disposed in the central region. Openings formed on each side of the surround are defined by the upper and lower aprons and the two fins extending from each corner on that side. The openings can deliver wind, from any direction, toward the wind turbine. The upper and lower aprons may angle inward to further concentrate and direct wind toward the wind turbine.

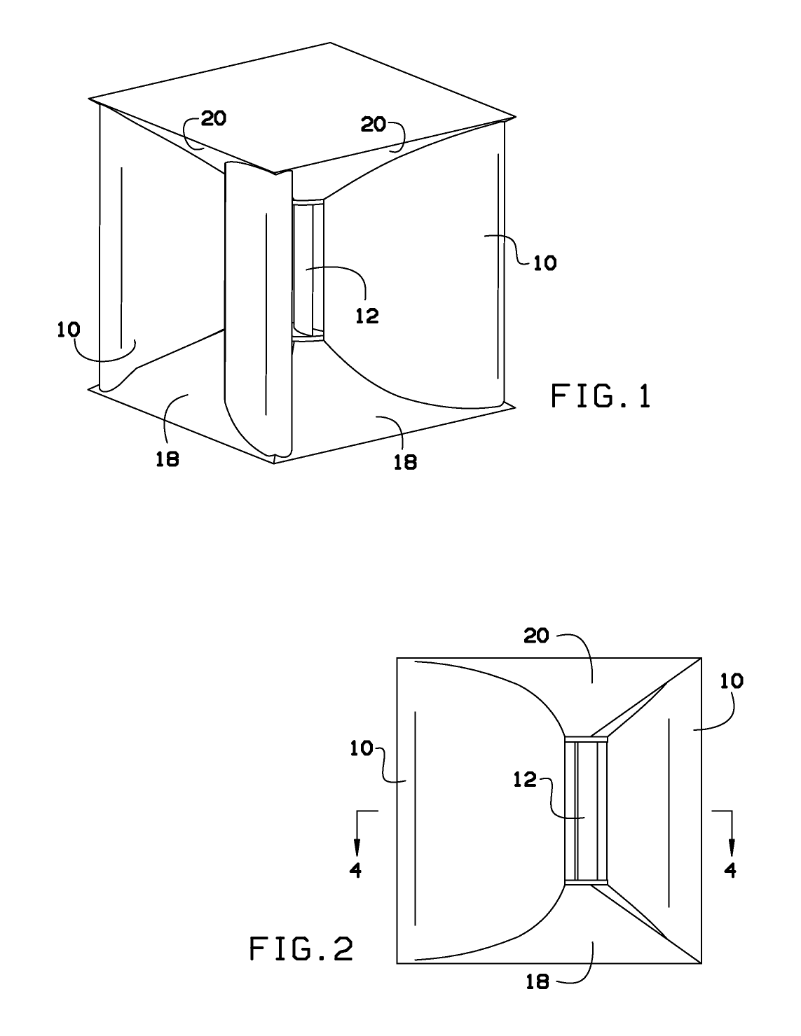

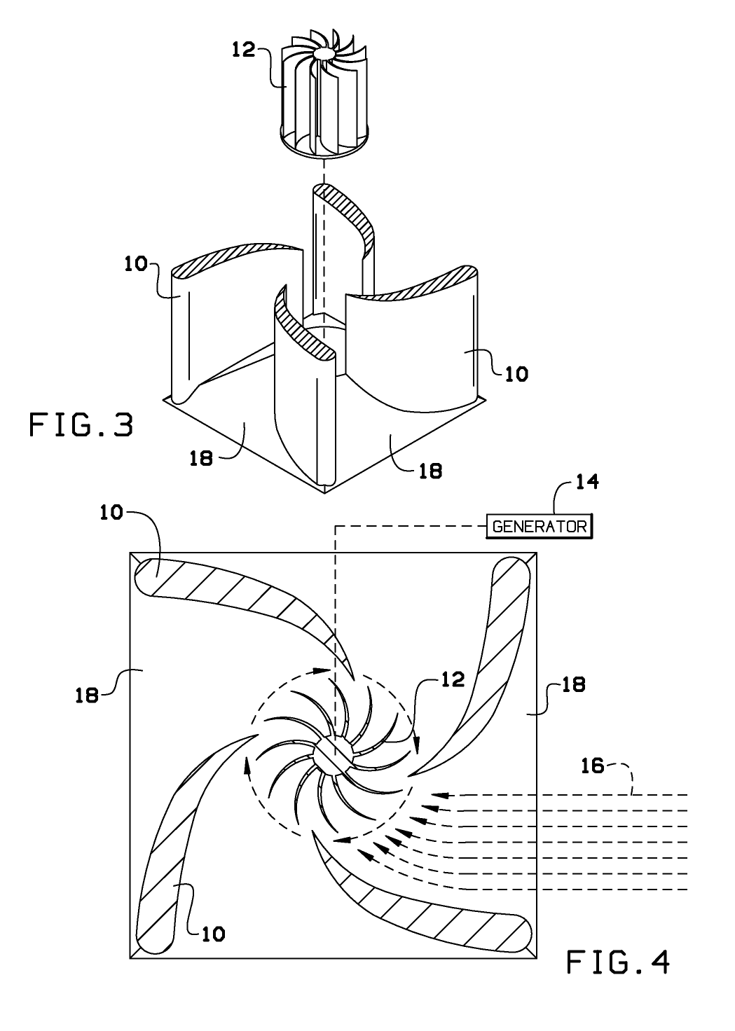

Referring now to FIGS. 1 through 5, a surround can include an upper apron 20 and a lower apron 18. Of course, the terms upper and lower when referring to the aprons 20, 18 are relative and refer to the direction provided in the Figures. The surround 10 can operate in an upside-down configuration where the upper and lower apron terminology can be reversed. Typically, the upper apron 20 and the lower apron 18 can have the same shape and these shapes are aligned one over the other for creation of the surround.

A wind turbine 12 can be disposed in between the upper apron 20 and the lower apron 18. The wind turbine 12 can be any type of wind turbine, typically a vertical axis wind turbine that is interconnected to a generator 14. The generator 14 can be any type of generator capable of turning mechanical rotational energy into electrical energy.

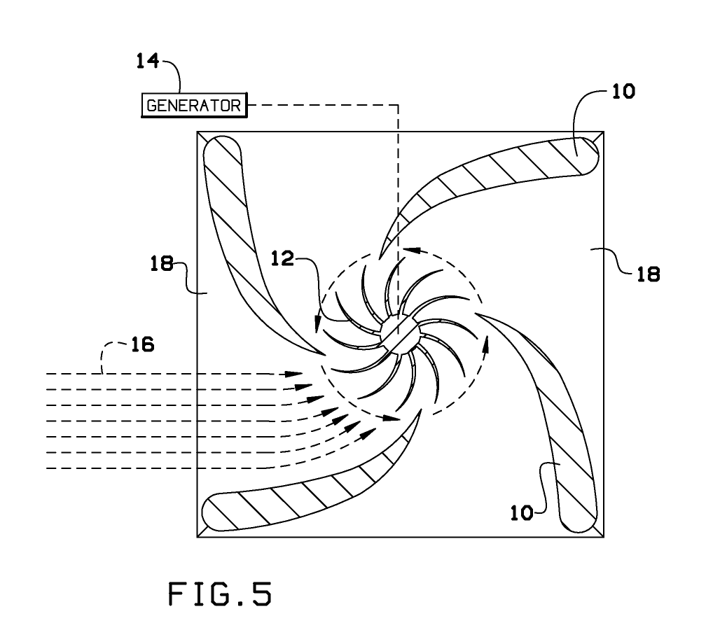

Fins 10 can be disposed between the upper apron 20 and the lower apron 18. The fins 10 extend from a corner of the upper apron 20 and the lower apron 18 to the wind turbine 12, as best illustrated in FIGS. 4 and 5, where it can be seen how wind 16 is concentrated as it passes into an opening defined by adjacent fins and the upper apron 20 and the lower apron 18. The fins 10 can be angled and can be formed with an aerodynamic shape to provide optimal impingement of wind 16 on the wind turbine 12. For example, the fins 10 can be angled to turn the wind 16 in a direction opposite of the direction of rotation of the wind turbine 12, as best illustrated again in FIGS. 4 and 5.

FIGS. 4 and 5 show two different orientations of the surround, where the wind turbine 12 is designed for clockwise rotation (FIG. 4) or counter-clockwise rotation (FIG. 5).

A height of the surround along an outer perimeter thereof can be greater than a height of the wind turbine 12. Therefore, the upper apron 20 and the lower apron 18 can be sloped from its outer perimeter to the wind turbine 12, thereby further concentrating the wind 16 along a vertical axis (due to the slope of the upper apron 20 and the lower apron 18) as well as along a horizontal axis (due to the action of the fins 10). The slope of the aprons can allow the generator 14 to be mounted within the surround itself, as may be desired for certain applications.

Typically, the upper apron 20 and the lower apron 18 have four sides, as shown in the Figures. This allows wind from any direction to enter the surround and be concentrated toward the wind turbine 12. However, surrounds having more or less number of sides may be effective and are contemplated within the scope of the present invention. At least three sides must be present to capture wind from any direction, however, greater than four sides may also be used with a similar effect. In some embodiments, the upper apron 20 and the lower apron 18 can be round, however, the fins 10 should define regions to collect and concentrate wind from 360 degrees about the surround.

It should be understood, of course, that the foregoing relates to exemplary embodiments of the invention and that modifications may be made without departing from the spirit and scope of the invention as set forth in the following claims.

What is claimed is:

1. A surround for a wind turbine, comprising:
an upper apron;
a lower apron;
a plurality of fins disposed between the upper apron and the lower apron; and
a central region formed between the upper apron and the lower apron operable to contain a wind turbine, wherein
the plurality of fins extend from an outer perimeter of the upper apron and the lower apron toward the central region, and
wind blowing on the surround from any direction is directed by the fins toward the central region.

2. The surround of claim 1, wherein the upper apron and the lower apron are rectangular and the plurality of fins are four fins extending from each corner of the upper apron and lower apron toward the central region.

3. The surround of claim 1, wherein the plurality of fins have an aerodynamic shape.

4. The surround of claim 3, wherein the plurality of fins are arched to direct wind toward the central region.

5. The surround of claim 1, wherein the central region has a height smaller than an height of the surround between the upper apron and the lower apron at the outer perimeter thereof.

6. The surround of claim 5, wherein the upper apron and the lower apron have a slope operable to direct wind toward the central region.

7. The surround of claim 1, further comprising a generator disposed in at least one of the upper apron and the lower apron.

8. A surround for a wind turbine, comprising:
an upper apron;
a lower apron;
a central region formed between the upper apron and the lower apron operable to contain a wind turbine; and
fins extending from each outer perimeter corner of the upper apron and the lower apron toward the central region, wherein
wind blowing on the surround from any direction is directed by the fins toward the central region;
the central region has a height smaller than an height of the surround between the upper apron and the lower apron at the outer perimeter thereof; and
the upper apron and the lower apron have a slope operable to direct wind toward the central region.

9. The surround of claim 8, wherein the upper apron and the lower apron are rectangular and the plurality of fins are four fins extending from each corner of the upper apron and lower apron toward the central region.

10. The surround of claim 8, wherein the plurality of fins have an aerodynamic shape.

11. The surround of claim 8, wherein the plurality of fins are arched to direct wind toward the central region.

12. The surround of claim 8, further comprising a generator disposed in at least one of the upper apron and the lower apron.
